(19) United States
(12) Patent Application Publication
(10) Pub. No.: US 2012/0199625 A1
(43) Pub. Date: Aug. 9, 2012

(54) METHODS AND APPARATUS FOR SCRIBING AND BREAKING LAYERS WITH CURVED EDGES

(76) Inventors: Jun Qi, Cupertino, CA (US); Wayne H. Fu, Mountain View, CA (US); Chenhui Wang, Cupertino, CA (US); Kuanying Lin, Mountain View, CA (US); Nathan K. Gupta, San Francisco, CA (US); Victor H. Yin, Cupertino, CA (US)

(21) Appl. No.: 13/021,399

(22) Filed: Feb. 4, 2011

(51) Int. Cl. B26F 3/00; B26D 3/08

(52) U.S. Cl. 225/2; 225/96

(57) ABSTRACT

Layers of material such as glass layers for displays may be cut using scribing and breaking techniques. Scribing-and-breaking equipment may include a scribe tip that forms a loop-shaped scribe line in the surface of a layer of material. The loop-shaped scribe line may have a rectangular shape with four straight sides and four rounded corners. A breaking structure such as a rectangular ring-shaped metal break frame with rounded corners may be configured to match the shape of the scribe line. During breaking operations, the layer of material may be supported on a support structure. The support structure may have a flexible material such as an elastomer and a lower-friction coating layer such as a polytetrafluoroethylene coating. The break frame may be aligned with the scribe line and may be used to press down on the layer of material, thereby breaking the layer of material along the scribe line.

### BACKGROUND

This relates generally to manufacturing techniques in which layers of material are patterned using scribe-and-break techniques, and, more particularly, to methods and apparatus for scribing-and-breaking layers of material such as glass layers for electronic device displays.

Flexible and malleable materials such as plastics and metals can often be cut using die cutting tools. Brittle materials such as glass and ceramics generally cannot be cut in this way. More typically, brittle materials are cut to size using scribing and breaking arrangements. For example, glass panels for electronic device displays are often cut using scribe-and-break techniques.

Typical scribe-and-break tools are limited to forming shapes with straight edges. Curved edge features such as curved corners cannot easily be formed. This can undesirably limit the types of components that can be created from layers of material that are patterned using scribe-and-break techniques. It may, for example, be difficult or impossible to manufacture cover glass layers for liquid crystal displays with curved corners.

It would therefore be desirable to be able to provide improved scribe-and-break techniques for patterning layers of material such as glass display layers.

### SUMMARY

Methods and apparatus for patterning layers of material are provided. The layers of material that are patterned may include glass layers, ceramic layers, or layers of other suitable material for which scribe-and-break cutting techniques are appropriate. As an example, the layers of patterned material may include layers in a display such as a cover glass, a glass color filter array layer, a glass thin-film transistor layer, a touch sensor substrate formed from glass, or other display layers.

Scribing-and-breaking equipment may be provided that includes a scribe tip and a positioner for moving the scribe tip. The scribe tip may be used to form a loop-shaped scribe line in the surface of a layer of material. The loop-shaped scribe line may have a rectangular shape with four straight sides and four rounded corners.

The scribing-and-breaking equipment may include a breaking structure such as a rectangular ring-shaped metal break frame with rounded corners. The shape of the breaking structure may be configured to match the shape of the scribe line. If, for example, the scribe line has a rectangular shape with rounded corners, the breaking structure may be implemented using ring-shaped rectangular member with a matching rectangular shape and rounded corners.

During breaking operations, the layer of material may be supported on a support structure. The support structure may have a flexible material such as an elastomer and a lower-friction coating layer such as a polytetrafluoroethylene layer. The breaking structure may be aligned with the scribe line and may be used to press down on the layer of material, thereby breaking the layer of material along the scribe line.

Further features of the invention, its nature and various advantages will be more apparent from the accompanying drawings and the following detailed description of the preferred embodiments.

### BRIEF DESCRIPTION OF THE DRAWINGS

FIG. 1 is a diagram of a conventional scribe-and-break system with a pair of parallel break bars that are being used to cut a piece of glass to size.

FIG. 2A is a perspective view of an illustrative electronic device such as a handheld electronic device of the type that may be provided with a display that has been fabricated using scribe-and-break techniques in accordance with an embodiment of the present invention.

FIG. 2B is a perspective view of an illustrative electronic device such as a portable computer of the type that may be provided with a display that has been fabricated using scribe-and-break techniques in accordance with an embodiment of the present invention.

FIG. 3 is a cross-sectional side view of an illustrative display containing layers of material that may be processed using scribe-and-break techniques in accordance with an embodiment of the present invention.

FIG. 4 is a perspective view of an illustrative system of the type that may be used in implementing scribe-and-break techniques to form display structures with curved edges in accordance with an embodiment of the present invention.

FIG. 5A is a cross-sectional side view of scribe-and-break equipment of the type that may be used to form curved edges in a workpiece in accordance with an embodiment of the present invention.

FIG. 5B is a cross-sectional side view of the equipment of FIG. 5A following scribe-and-break operations to remove excess portions of a workpiece in accordance with an embodiment of the present invention.

FIG. 6 is a top view of a workpiece such as a display cover glass layer with curved edges of the type that may be formed using scribe-and-break techniques in accordance with an embodiment of the present invention.

FIG. 7 is a diagram of scribing equipment that may be used to create curved scribe lines on the surface of a display layer or other workpiece in accordance with an embodiment of the present invention.

FIG. 8 is a diagram of breaking equipment that may be used to break a display layer or other workpiece along curved scribe lines on the surface of the display layer or other workpiece in accordance with an embodiment of the present invention.

FIG. 9 is a diagram showing processing operations and equipment that may be used in forming electronic devices and other structures from layers of material that are patterned using scribe-and-break techniques in accordance with an embodiment of the present invention.

### DETAILED DESCRIPTION

Layers of brittle material such as glass and ceramic layers are often used in forming electronic devices and other structures. As one example, layers of glass are often used in forming displays for electronic devices.

Displays may be used in device such as computer monitors, laptop computers, media players, cellular telephones and other handheld devices, tablet computers, televisions, and other equipment. Displays may be based on plasma technology, organic light-emitting-diode technology, liquid crystal structures, etc.

Displays typically include glass layers. For example, a liquid crystal display may include a color filter array layer that includes colored filter elements, a thin-film-transistor layer that includes thin-film transistors for controlling the application of electric fields to liquid crystal image pixels. A touch sensor array for a display may be implemented by creating an array of transparent capacitor electrodes on a transparent substrate. A cover layer may be used to cover the display. The cover layer and other display layers such as the colored filter array layer, thin-film-transistor layer, and touch sensor substrate layer, may be formed from clear glass.

Displays also generally include other layers of material such a polymer layers. A typical liquid crystal display may, for example, include polymer layers associated with polarizers, antireflection coatings, substrates for touch sensor arrays, birefringent (compensating) films, light guide plates, diffusers, etc.

Polymer layers can be cut to a desired size using techniques such as die stamping techniques. Glass layers are typically cut to size using scribe-and-break techniques.

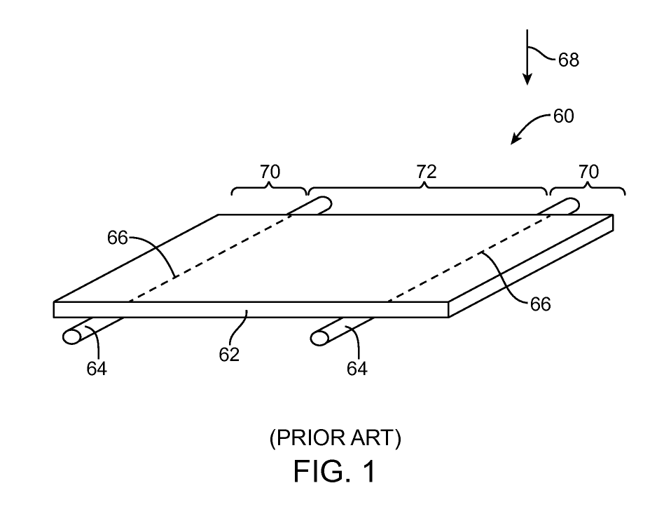

A conventional scribe-and-break arrangement is shown in FIG. 1. As shown in FIG. 1, scribe-and-break system 60 includes a workpiece such as glass layer 62 and break bars 64. To cut glass layer 62 to size, scribe lines such as parallel scribe lines 66 are formed on the upper surface of layer 62. Once scribe lines 66 have been formed, glass layer 62 may be placed on top of break bars 64. By pressing downwards in direction 68, end portions 70 of glass layer 62 may be broken away from central portion 72 of glass layer 62 along scribe lines 66. While conventional break-bar systems of the type shown in FIG. 1 are generally satisfactory for forming a set of parallel straight cuts, they cannot be used in forming more complex patterns such as shapes with curved cuts.

It may be desirable to cut curved edges into glass layers. For example, it may be desirable to form a cover layer or other display layer into a rectangular shape with curved corners. Such display layers may be suitable for incorporation into electronic device housings with curved corners and may help enhance device aesthetics.

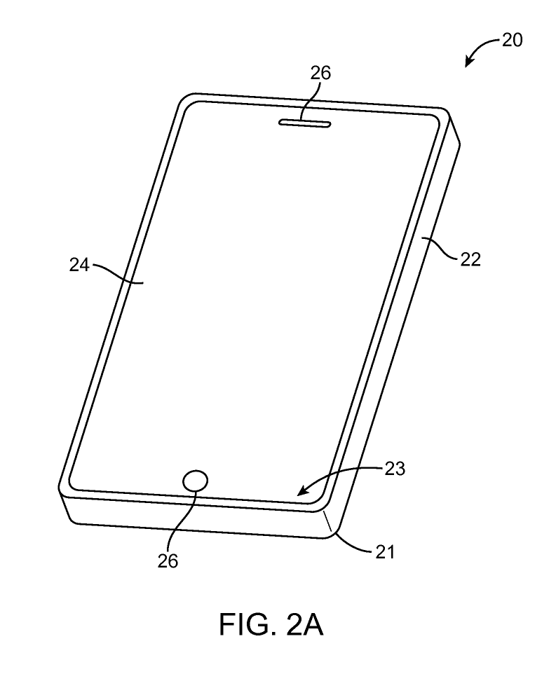

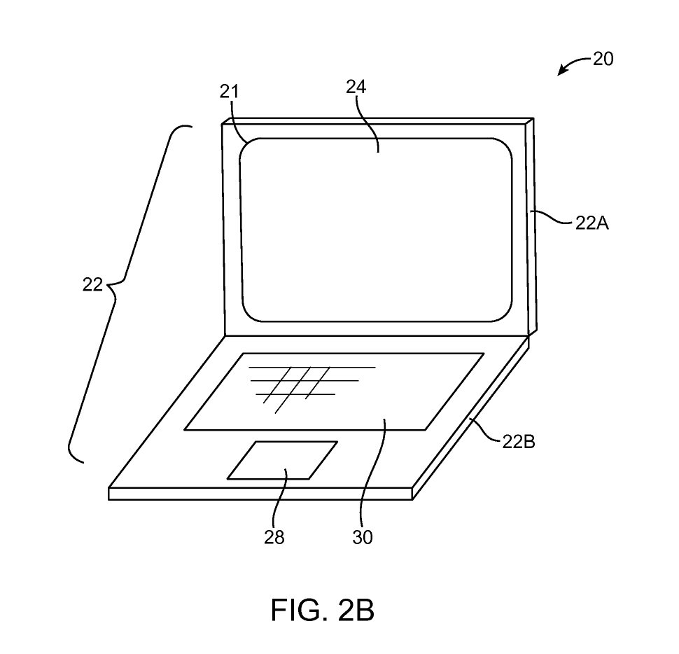

Illustrative electronic devices that have housings with rounded corners and that may be suitable for displays with rounded corners or other structures with curved edges are shown in FIGS. 2A and 2B.

A perspective view of an illustrative electronic device such as a handheld electronic device that may be provided with a display or other structures with curved edges formed using scribe-and-break equipment is shown in FIG. 2A. As shown in FIG. 2A, electronic device 20 may have a housing such as housing 22. Housing 22 may be formed from materials such as plastic, glass, ceramic, metal, fiber composites, and combinations of these materials. Housing 22 may have one or more sections. In the arrangement of FIG. 2A, device 20 has a front face and a rear face. Display 24, which may include one or more display layers such as glass layers, may be mounted on the front face of housing 22. Openings 26 may be provided in display 24. For example, openings 26 may be used to form speaker ports, button openings, and other openings in a cover glass layer for display 24 or in other display layers. Housing corners 21 and display corners 23 (e.g., the corners of a cover glass layer and other display layers in display 24) may be curved.

A perspective view of another illustrative electronic device of the type that may be provided with a display or other structures with curved edges formed using scribe-and-break equipment is shown in FIG. 2B. In the example of FIG. 2B, housing 22 has upper portion 22A and lower portion 22B. Portions 22A and 22B may be attached using a hinge. Upper portion 22A may be used to house display 24. Processing circuitry and input-output components such as track pad 28 and keyboard 30 may be provided in lower portion 22B. Device 20 of FIG. 2B may be, for example, a portable computer. Corners 21 of display 24 may be curved. Housing corners in device 20 of FIG. 2B may also be curved, if desired.

In other illustrative electronic devices (e.g., tablet computers, music players, etc.), displays such as display 24 and other electronic device components may be mounted in housings 22 with other configurations. The display mounting arrangements of FIGS. 2A and 2B are merely illustrative.

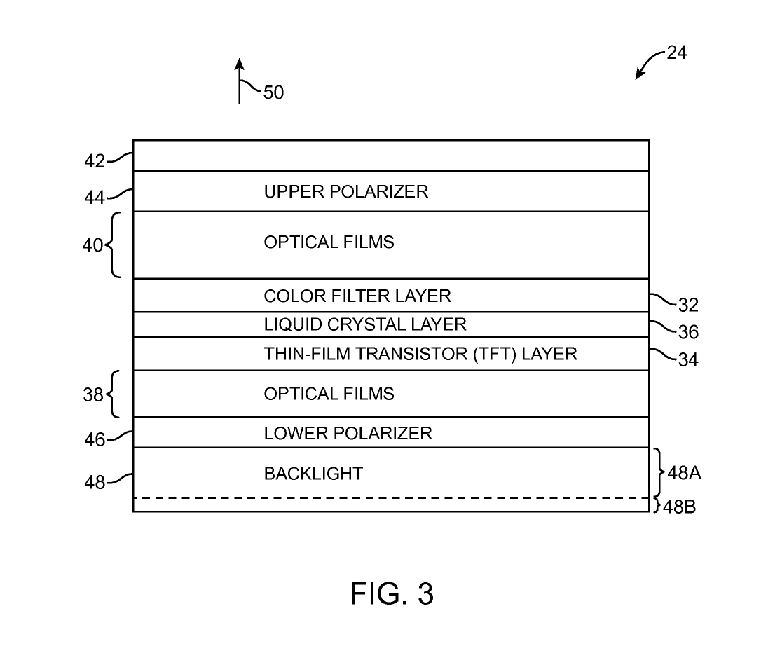

A cross-sectional side view of an illustrative display of the type that may be incorporated into an electronic device is shown in FIG. 3. The illustrative display of FIG. 3 is a liquid crystal display (as an example). Other types of displays may be provided for electronic devices if desired.

As shown in FIG. 3, display 24 may include color filter layer 32 (sometimes referred to as a color filter array layer) and thin-film-transistor layer 34. Color filter layer 32 may include an array of colored filter elements. In a typical arrangement, the pixels of layer 32 each include three types of colored pixels (e.g., red, green, and blue subpixels). Liquid crystal layer 36 includes liquid crystal material and is generally interposed between color filter layer 32 and thin-film-transistor layer 34. Thin-film-transistor layer 34 may include electrical components such as thin film transistors, capacitors, and electrodes for controlling the electric fields that are applied to liquid crystal layer 36.

Optical film layers 38 and 40 and display layers 42 may be formed above and below color filter layer 12, liquid crystal layer 16, and thin-film-transistor layer 14. Optical films 18 and 20 may include structures such as quarter-wave plates, half-wave plates, diffusing films, optical adhesives, and birefringent compensating layers. Display layers 42 may include films of this type and/or other display structures such as a cover glass layer or polymer cover layer, an antireflection coating layer, coatings for resisting fingerprints and scratching, a touch sensor array (e.g., a touch sensor array of transparent capacitive electrodes such as indium tin oxide electrodes patterned on a clear substrate such as a glass or polymer substrate), etc.

Display 24 may have upper and lower polarizer layers 44 and 46. Backlight 48 may provide backside illumination for display 24. Backlight 48 may include a light source such as a strip of light-emitting diodes. Backlight 48 may also include light-guide plate 48A and back reflector 48B. Back reflector 48B may be located on the lower surface of the light-guide plate to prevent light leakage and may be formed from a polymer such as white polyester or other reflective materials. Light-guide plate 48A may be formed from a clear polymer. Light from the light source may be injected into an edge of the light-guide plate and may scatter upwards in direction 50 through display 24. Layers of adhesive may be interposed between the layers of display 24 during assembly.

The layers in display 24 may be formed from any suitable materials. The display layers above those in backlight 48 are generally transparent to allow light to propagate in direction 50. Suitable display layer materials include polymers, glass, ceramic, fiber-based composites, etc. In a typical arrangement, the cover layer in layer 42 may be formed from a glass plate, the substrates for color filter layer 32 and thin-film-transistor layer 34 may be formed from glass panels, and glass or polymer may be used for forming an optional planar touch sensor array substrate for a touch sensor in layers 42. The other layers of material in display 24 (e.g., the coating layers and other display layers in layers 42, upper and lower polarizers 44 and 46, optical films 40 and 46, and the layers in backlight 48) are typically formed from polymers. This is, however, merely an example. In some displays, some of the layers that are often formed from polymers may be formed from glass, ceramic, or other materials and some of the layers that are often formed from glass layers may be formed from polymer, ceramic, or other materials.

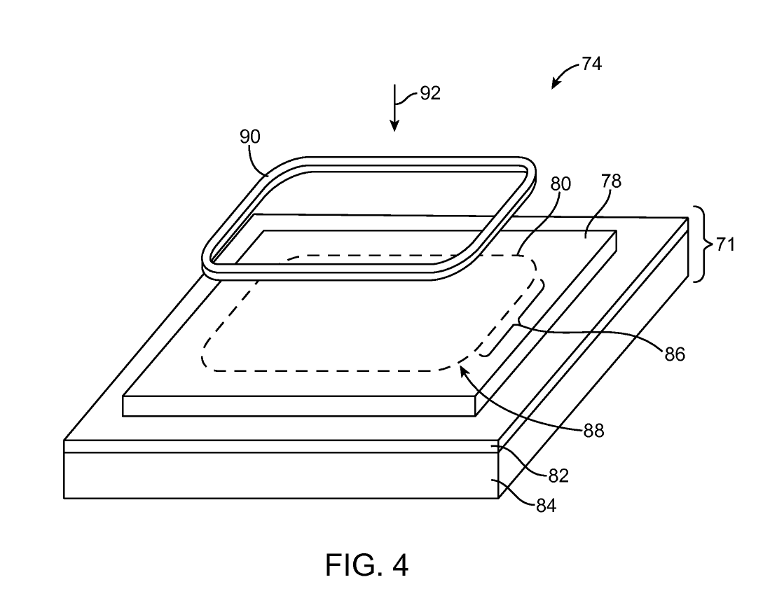

Illustrative scribing-and-breaking equipment that may be used to cut display layers such as glass layers in display 24 of FIG. 3 into shapes with curved edges is shown in FIG. 4. As shown in FIG. 4, system 74 may include break frame 90 and support structure 76. Workpiece 78 may rest on the upper surface of support structure 76. Workpiece 78 may be a plate of glass, ceramic, or other material that is suitable for cutting using scribing and breaking techniques. For example, workpiece 78 may be a cover glass layer for a display, a display layer such as a color filter layer or thin-film transistor layer, a display layer such as a touch sensor array substrate, a glass layer for other structures, etc.

During scribing operations, a scribing tool may be used to form a scribe line such as scribe line 80 in the lower surface of workpiece 78 (i.e., the surface of workpiece 78 that is resting on the upper surface of support structure 76 in the orientation of FIG. 4). The scribe line may include straight sections (e.g., four sides) such as straight portion 86 and curved sections (e.g., four rounded corners) such as curved corner section 88. The area of workpiece 78 that is surrounded by scribe line 80 may correspond to a rectangle with rounded corners or other desired shape for a display cover glass layer or other structure. In a typical arrangement, scribe line 80 forms a closed loop (i.e., scribe line 80 does not exit the edge of workpiece 78, but rather forms a continuous uninterrupted line that completely surrounds a portion of the workpiece). If desired, scribe line 80 may form an open shape such as a three-sided rectangle with curved corners, etc.

Support 76 may be formed from one or more materials. In the example of FIG. 4, support 76 has been formed from two layers. Lower layer 84 may be formed from a flexible material such as foam, soft plastic, or other elastomeric substance. Upper layer 82 may be formed from a low-friction material such as a layer of polytetrafluoroethylene or other slippery coating (i.e., a layer having a lower coefficient of friction than layer 84). During breaking operations, the slippery surface of layer 82 in support structure 76 may help facilitate formation of a clean break in workpiece 78.

Breaking structures such as break frame 90 may be formed from one or more pieces of metal or other suitable materials with sufficient strength to bear sharply against the upper surface of workpiece 78 to break workpiece 78 into its desired shape. As shown in the illustrative configuration of FIG. 4, break frame 90 may be formed from a ring-shaped structure that matches the ring-shaped (loop-shaped) pattern of scribe line 80. In this example, both scribe line 80 and break frame 90 are rectangular with rounded corners. Other patterns may be used for scribe line 80 and break frame 90 is desired. When break frame 90 is moved downwards in direction 92, the lower surfaces of break frame 90 press against workpiece 78 in alignment with scribe line 80. This causes workpiece 78 to break apart along scribe line 80 and separates the excess peripheral portions of layer 78 from the desired central portion of layer 78 corresponding to the area bounded by scribe line 80.

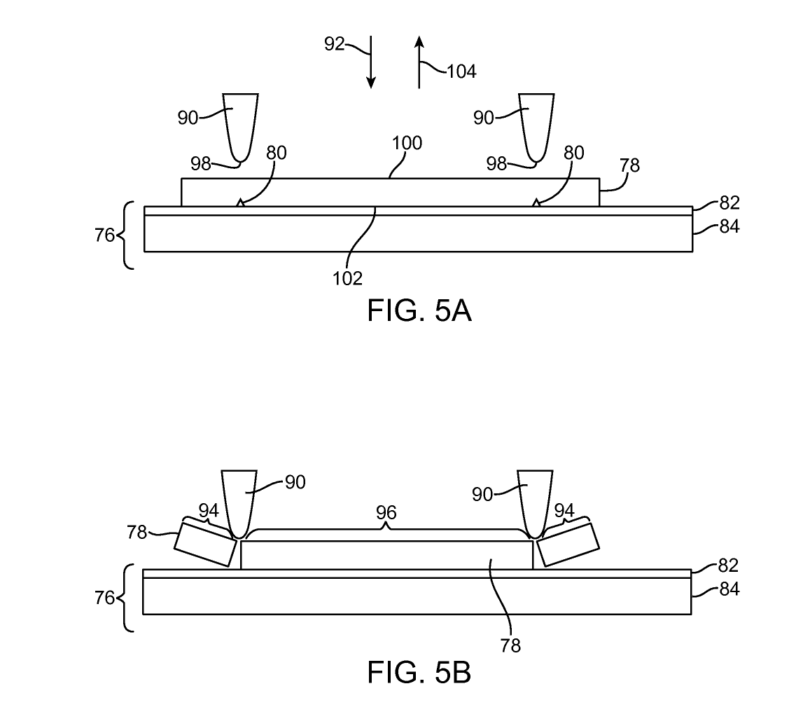

The cross-sectional side views of FIG. 5A and 5B illustrate how break frame 90 may be used in separating edge portions of workpiece 78 from the desired central portion of workpiece 78.

FIG. 5A shows how protruding portions 92 of break frame 90 may be aligned over scribe line 80 prior to movement of break frame 90 towards workpiece 78. Workpiece 78 may have upper (outer) surface 100 and lower (inner) surface 102. Scribe line 80 may be formed in lower surface 102 (e.g., in the form of a rectangle with straight sides and rounded corners or other suitable shapes). Lower surface 102 may rest against the upper surface of support structure 76. In configurations in which support structure 76 contains multiple layers such as elastomeric layer 84 and friction-reducing layer 82 (i.e., a layer with a lower coefficient of friction than layer 84), lower surface 102 may rest on friction-reducing layer 82. Portions 98 of break frame 90 may be pointed (e.g., to form sharp downwardly projecting tips, smoothly rounded tips, etc.) or may have other shapes that facilitate the process of breaking workpiece 78 along scribe line 80.

To break workpiece 78 into its desired shape, break-inducing structures such as break frame 90 may be pressed against upper surface 100 of workpiece 78 (i.e., the surface opposing surface 102) so that tips 98 are aligned with scribe line 80. Break frame 90 may be pressed against workpiece 78 by moving break frame 90 downwards in direction 92, by moving workpiece 78 upwards in direction 104, or by moving break frame 90 downwards while moving support 76 and workpiece 78 upwards.

As tips 98 of break frame 90 contact upper surface 100 of workpiece 78 and press downwards on workpiece 78, scribe line 80 initiates formation of cracks in workpiece 78. As shown in FIG. 5B, this separates undesired peripheral portions 94 of workpiece 78 from desired central portion 96. The flexibility of layer 84 of support structure 76 helps break frame 90 bend workpiece 78 sufficiently to initiate breaking at scribe line 80. The slippery coating on support structure 76 that is formed by low-friction layer 82 may prevent portions 94 of workpiece 78 from becoming stuck in place on the surface of support structure 76 during breaking operations.

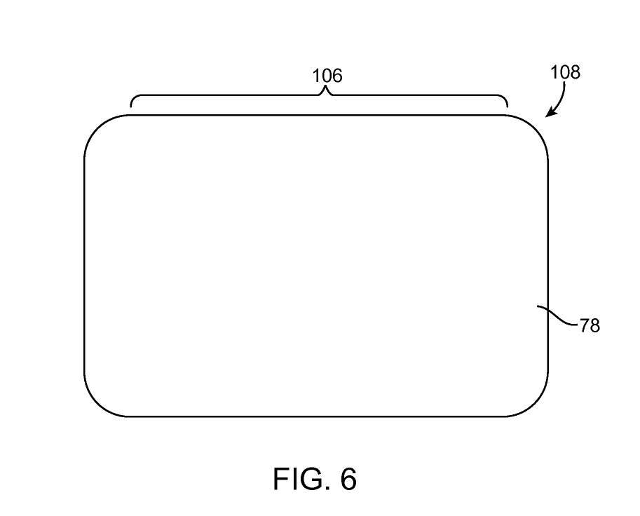

After portions 94 have been broken away from portion 96, workpiece 78 may have its intended final shape, such as the rectangular shape of FIG. 6. As shown in the FIG. 6 example, workpiece 78 may have four straight edges such as edge 106 and four curved corners such as corner 108). The peripheral edge of workpiece 78 of FIG. 6 corresponds to the shape of scribe line 80 on workpiece 78 of FIG. 4.

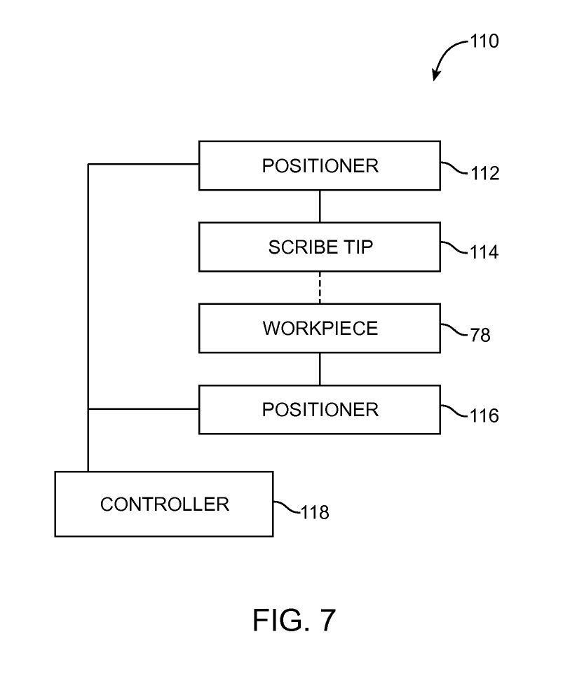

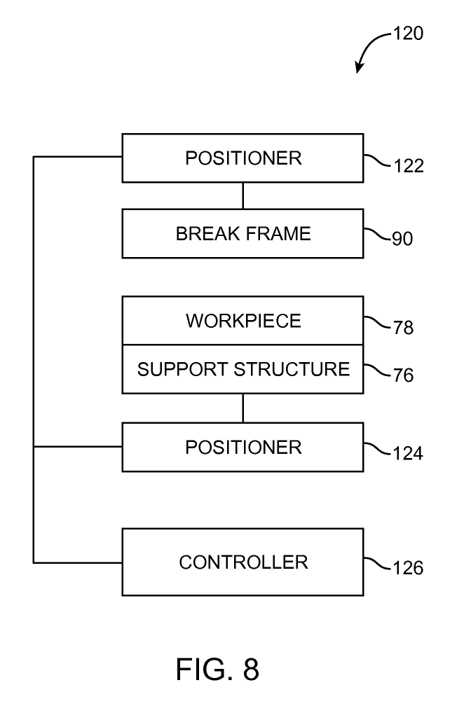

If desired, scribing and breaking operations may be performed using computer-controlled equipment. An illustrative scribing tool is shown in FIG. 7. An illustrative breaking tool for breaking workpiece 78 along its scribe line is shown in FIG. 8.

As shown in FIG. 7, scribing equipment 110 may include a scribe tip such as scribe tip 114. Scribe tip 114 may have a diamond point or other hard tip for forming scribe lines such as scribe line 80 in workpiece 78. Workpiece 78 may be a layer of glass, ceramic, or other material that is suitable for cutting using scribe-and-break techniques. Workpiece 78 may be, for example, a glass layer such as a glass display layer (e.g., a layer of cover glass, etc).

The position of scribe tip 114 may be controlled using positioner 112. The position of workpiece 78 may be adjusted using positioner 116. Positioners 112 and 116 may be motors, solenoids, or other suitable positioning equipment. Controller 118 may issues control commands to positioners 112 and 116 to control the relative position between scribe tip 114 and workpiece 78. Controller 118 may be based on one or more processors, one or more computers or other computing equipment. During operation of system 110, a scribe line may be formed on the surface of workpiece 78 using scribe tip 114. For example, controller 118 may direct system 110 to scribe a scribe line such as scribe line 80 of FIG. 4 on lower surface 102 of workpiece 78 (FIG. 5A).

Following scribing operations, workpiece 78 may be processed using equipment such as breaking equipment 120 of FIG. 8. As shown in FIG. 8, equipment 120 may include workpiece breakage promotion structures such as break frame 90 or other breaking structures. Break frame 90 may be formed from a ring-shaped member such as structure 90 of FIG. 4 or may be formed using other one or more other structures that can be aligned with scribe line 80 on workpiece 78.

Workpiece 78 may be supported on support structure 76. Support structure 76 may have a low-friction coating such as coating 82 of FIG. 4 and may be flexible (e.g., due to the use of foam, rubber, other elastomeric substances in layer 84). The flexible nature of support structure 76 may help allow workpiece 78 to flex downwards somewhat in the vicinity of scribe line 80 when subjected to pressure from break frame 90. This slight flexing of workpiece 78 may help promote breaking of workpiece 78 along scribe line 80.

Positioner 122 may be used in controlling the position of break frame 90. The position of workpiece 78 and support structure 76 may be adjusted using positioner 124. Positioners 122 and 124 may be formed from motors, solenoids, or other positioning equipment. Controller 126 may be used to control positioners 122 and 124 so as to adjust the relative position between break frame 90 and workpiece 78. To break undesired peripheral portions 94 of workpiece 78 away from central portion 96, break frame 90 may be moved towards workpiece 78 by positioner 122 and/or support structure 76 and workpiece 78 may be moved towards break frame 90 by positioner 124.

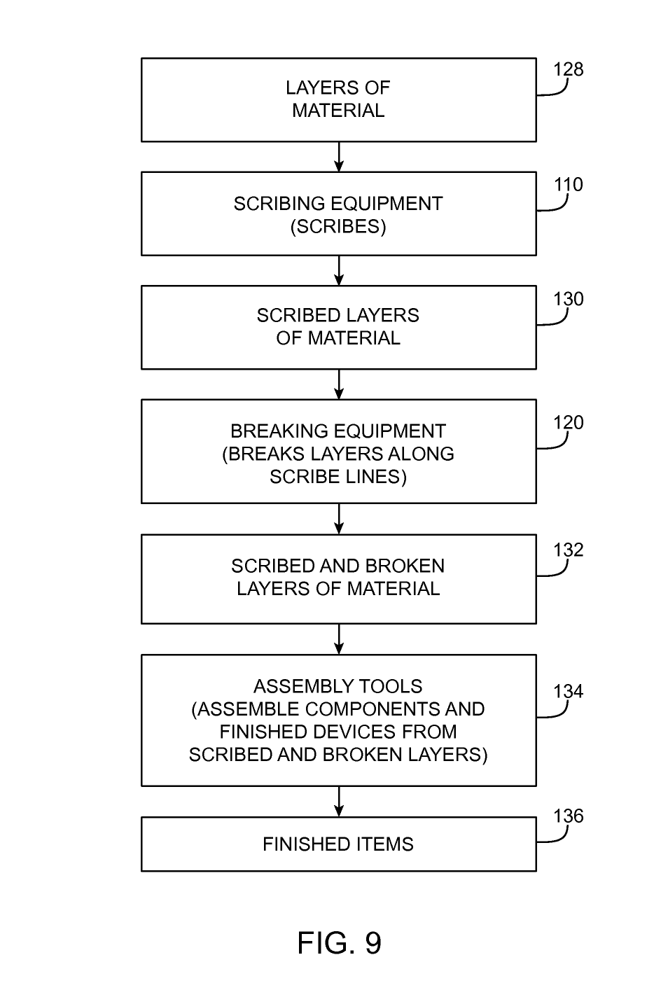

Illustrative equipment and operations involved in shaping workpiece 78 using scribe-and-break equipment such as equipment 110 of FIG. 7 and equipment 120 of FIG. 8 are shown in FIG. 9.

As shown in FIG. 9, layers of material 128 for forming a finished item such as a display or other component for electronic device 20 may be provided to scribing equipment 110. Layers 128 may include glass layers such as a cover glass layer, a glass color filter array layer, a glass thin-film-transistor layer, a glass substrate for a capacitive touch sensor array, or other suitable glass layers. Layers 128 may also include layers of other material that are suitable for pattering using scribe-and-break techniques (e.g., ceramics, laminated layers of glass and/or other materials, etc.).

As described in connection with FIG. 7, scribing equipment 110 may be used to scribe the surface of one or more layers of material 128 (i.e., workpiece 78). The shape of the scribe line that is formed may be a closed loop such as a rectangle with rounded corners that completely surrounds and encloses a desired central portion of workpiece 78 (i.e., a desired rectangular shape with rounded corners for a cover glass layer or other display layer). Other types of scribe line patterns may be used if desired (e.g., other shapes with curved edge portions, other shapes with combinations of straight and curved section, shapes that run off the side of workpiece 78, etc.).

Following formation of scribe line 80 with scribing equipment such as scribing equipment 110 of FIG. 9, the scribed layer(s) of material (i.e., scribed workpiece 78 of FIG. 5B) may be processed using breaking equipment 120 (FIG. 8). In particular, equipment 120 may use its positioners or other mechanisms to press break frame 90 against the surface of workpiece 78 opposing the surface of workpiece 78 that includes scribe line 80. During breaking operations, workpiece 78 may be supported by a flexible support structure such as support structure 76, facilitating formation of a clean break in workpiece 78 along scribe line 80.

The resulting scribed and broken (patterned) workpiece (i.e., one of layers 132 of FIG. 9) may be provided to assembly tools 174. Assembly tools 134 may include lamination tools for combining display layers using adhesive to form displays and other components, tools for attaching display components to housing structures, and other tools for forming finished components and electronic devices from layers such as scribed and broken layers 132.

The assembly processes performed using assembly tools 134 result in finished structures 136 such as finished displays and other electronic device components, electronic devices that include such components, other items, etc.

The foregoing is merely illustrative of the principles of this invention and various modifications can be made by those skilled in the art without departing from the scope and spirit of the invention. The foregoing embodiments may be implemented individually or in any combination.

What is claimed is:

1. A method of patterning a layer of material, comprising:
forming a loop-shaped scribe line onto a surface of the layer of material; and
breaking the layer of material along the scribe line using a break frame structure that is aligned with the loop-shaped scribe line.

2. The method defined in claim 1 wherein scribing the loop-shaped scribe line comprises scribing a rectangular scribe line with rounded corners.

3. The method defined in claim 1 wherein the loop-shaped scribe line encloses a substantially rectangular area of the material with curved corners and wherein breaking the layer of material comprises breaking away portions of the layer of material other than the rectangular area.

4. The method defined in claim 1 wherein the layer of material comprises a glass layer, wherein the loop-shaped scribe line defines a rectangular area with rounded corners on the glass layer, and wherein breaking the layer of material comprises pressing the break frame structure against the glass layer.

5. The method defined in claim 1 further comprising:
supporting the glass layer on a flexible support structure, wherein pressing the break frame structure against the glass layer comprises pressing the break frame structure against the glass layer while the glass layer is supported on the flexible support structure.

6. The method defined in claim 5 wherein the flexible support structure comprises an elastomeric layer and a coating layer having a lower coefficient of friction than the elastomeric layer and wherein supporting the glass layer on the flexible support structure comprises placing the glass layer on the coating layer.

7. The method defined in claim 1 wherein forming the scribe line comprises using at least one positioner and at least one scribe tip to scribe a rectangular line with curved corners onto the surface of the layer of material.

8. The method defined in claim 7 wherein the break frame structure comprises a ring-shaped structure with a shape matching the loop-shaped scribe line and wherein breaking the layer of material along the scribe line using the break frame structure comprises breaking the layer of material along the scribe line by moving the ring-shaped structure towards the scribe line.

9. The method defined in claim 8 wherein moving the ring-shaped structure towards the scribe line comprises moving the ring-shaped structure using a positioner that is controlled by a controller.

10. The method defined in claim 8 wherein the layer of material comprises a glass display layer, the method further comprising supporting the glass display layer on an elastomeric support structure layer, and wherein moving the ring-shaped structure towards the scribe line comprises moving the ring-shaped structure towards the scribe line while supporting the glass display layer on the elastomeric support structure layer.

11. Apparatus for cutting a layer of material having a surface that contains a scribe line with a loop shape, comprising:
a breaking structure having a shape that matches the loop shape of the scribe line and that is configured to press against the layer of material in alignment with the scribe line; and
a support structure on which the layer of material is supported while the breaking structure presses against the layer of material.

12. The apparatus defined in claim 11 wherein the breaking structure comprises a ring-shaped break frame.

13. The apparatus defined in claim 12 further comprising:
at least one positioner that makes position adjustments to the breaking structure; and
a controller that controls the positioner.

14. The apparatus defined in claim 11 wherein the scribe line has at least one curved section and wherein the breaking structure has a shape that matches the shape of the scribe line and curved section.

15. The apparatus defined in claim 11 further comprising:
a scribe tip; and
a positioner that moves the scribe tip across the surface of the layer of material to form the scribe line.

16. The apparatus defined in claim 11 wherein the support structure comprises multiple support structure layers.

17. The apparatus defined in claim 16 wherein one of the support structure layers comprises polytetrafluoroethylene.

18. The apparatus defined in claim 17 wherein one of the support structure layers comprises an elastomeric material.

19. A method for forming a glass layer having a rectangular shape and curved corners, comprising:
forming a rectangular scribe line on a surface of the glass layer, wherein the rectangular scribe line has four straight sides and four rounded corners; and
using a breaking structure having a shape that matches the rectangular scribe line to break the glass layer along the rectangular scribe line.

20. The method defined in claim 19 wherein the breaking structure comprises a ring-shaped rectangular break frame with rounded corners that is in alignment with the rectangular scribe line and wherein using the breaking structure comprises pressing the ring-shaped rectangular break frame against a surface of the glass layer opposing the surface on which the rectangular scribe line is formed.

21. The method defined in claim 20 further comprising:
supporting the glass layer on a support structure that includes flexible material while pressing the glass layer with the ring-shaped rectangular break frame.

22. The method defined in claim 21 wherein the glass layer comprises a glass layer selected from the group consisting of: a display cover glass layer, a color filter layer, a thin-film transistor layer, and a touch sensor substrate layer, wherein the support structure comprises a layer of material that has a lower coefficient of friction than the flexible material and that covers the flexible material, and wherein supporting the glass layer comprises supporting the glass layer on the layer of material that has the lower coefficient of friction and the flexible material.
